(19) United States
(12) Patent Application Publication
(10) Pub. No.: US 2009/0107047 A1
(43) Pub. Date: Apr. 30, 2009

(54) GARAGE DOOR PANEL WITH THERMOSET OVERLAY ELEMENT AND RELATED METHODS

(75) Inventors: Brian M. Magill, Cincinnati, OH (US); Jeffrey W. Stone, Lebanon, OH (US)

Correspondence Address: WOOD, HERRON & EVANS, LLP, 2700 CAREW TOWER, 441 VINE STREET, CINCINNATI, OH, 45202, US

(73) Assignee: CLOPAY BUILDING PRODUCTS R&D COMPANY, INC., Mason, OH (US)

(21) Appl. No.: 11/928,310

(22) Filed: Oct. 30, 2007

(51) Int. Cl. E05D 15/38

(52) U.S. Cl. 49/197; 160/229.1; 29/469.5

(57) ABSTRACT

A garage door has pivotally connected door panels, with each of the door panels including an outer skin having an outer surface. The outer skin has a metal, such as steel, having a first coefficient of thermal expansion. An overlay element, such as a decorative element, is coupled to the outer surface of at least one of the outer skins. The overlay element includes a fiber-reinforced thermoset material having a second coefficient of thermal expansion. In one specific embodiment, the first and second coefficients of thermal expansion are substantially equal. In one embodiment, the overlay element includes a pultruded fiber-reinforced thermoset material. In yet another aspect, the overlay element is adhesively coupled to said outer surface. Adhesive coupling may, for example, include a hot-melt adhesive, a two-part glue, or double-sided adhesive tape.

### FIELD OF THE INVENTION

This invention is generally related to overhead-type garage doors and, more particularly, to overhead sectional door panels having overlay elements on a surface thereof.

### BACKGROUND OF THE INVENTION

Overhead or retractable doors that are commonly used for garage doors, truck doors, warehouse doors or the like. Known overhead doors of this type are convertible between an open, overhead or generally horizontal configuration and a closed, generally vertically oriented configuration in which the door closes an opening in a building, vehicle or the like. Known overhead doors are movable along a track assembly mounted proximate the opening and the track assembly includes a generally vertical track section, a generally horizontal track section and a curved transition track section joining the horizontal and vertical track sections together.

Overhead doors of this type are conventionally constructed of a number of vertically arranged, horizontally oriented panels which can fold along horizontal divisions between the panels to enable the door to pass along the curved transition section of the track when being opened or closed. The panels can be pivotally coupled together with hinges on the interior surface or back face of the door panels. The hinges articulate during pivotal movement of the panels. Such door panels for many years were predominantly constructed of wood. However, wood door panels are both costly to manufacture and heavy in use, resulting in difficulty when opening and closing the garage door.

To address the drawbacks of wood door panels, sectional overhead door panels having an outer metal skin have replaced wooden door panels in many applications. To produce lightweight door panels with desirable strength and rigidity, however, it becomes sometimes desirable to integrate various elements with the door panel. It is sometimes desirable to add decorative overlay elements to a surface of such door panels for ornamental purposes.

The addition of overlay elements for structural or decorative purposes, however, presents known challenges. For example, when exposed to relatively high ambient temperatures, the overlay element will expand or contract. More particularly, an overlay element may expand or contract at a rate and by an amount that is different from that of the underlying outer skin of the door panel. This expansion or contraction results in added stresses on coupling elements such as adhesives or fasteners that allow attachment of the overlay element to the skin of the door panel.

A need exists, therefore, for an overhead door panel having overlay elements and which addresses one or more of the drawbacks noted above.

### SUMMARY OF THE INVENTION

The various embodiments of this invention offer these and other advantages over known overhead door and panel designs. In one embodiment, a garage door has pivotally connected door panels, with each of the door panels including an outer skin having an outer surface. The outer skin is metal, such as steel and has a first coefficient of thermal expansion. An overlay element, such as a decorative element, is coupled to the outer surface of at least one of the outer skins. The overlay element includes a fiber-reinforced thermoset material having a second coefficient of thermal expansion. In one specific embodiment, the first and second coefficients of thermal expansion are substantially equal.

In one embodiment, the overlay element includes a pultruded fiber-reinforced thermoset material. In yet another aspect, the overlay element is adhesively coupled to the outer surface. The adhesive may, for example, include a hot-melt adhesive, a two-part glue, or double-sided adhesive tape.

In other embodiments of this invention, a door panel for use as a component of an overhead garage door includes a body portion and an outer skin coupled to the body portion. The outer skin includes a metallic outer surface, for example steel and has a first coefficient of thermal expansion. An overlay element such as a decorative element is coupled to the outer surface and includes a fiber-reinforced thermoset material having a second coefficient of thermal expansion. In one specific embodiment, the first and second coefficients of thermal expansion are substantially equal. In another aspect, the overlay element is a pultruded fiber-reinforced thermoset material. The overlay element may be adhesively coupled to the outer surface such as with a hot-melt adhesive, a two-part glue, or double-sided adhesive tape.

In yet another embodiment of this invention, a method of making a panel for an overhead door includes the step of roll-forming a metal sheet into an outer skin of the panel. An overlay element is formed from a fiber-reinforced thermoset material and mounted onto an outer surface of the outer skin of the panel. The first coefficient of thermal expansion of the metal sheet is matched with a second coefficient of thermal expansion of the fiber-reinforced thermoset material.

### BRIEF DESCRIPTION OF THE DRAWINGS

The objectives and features of the invention will become more readily apparent from the following detailed description taken in conjunction with the accompanying drawings in which:

FIG. 1 is a perspective view of an exemplary overhead door with associated panels according to one embodiment of this invention;

FIG. 2 is a fragmented side elevational and cross-sectional view of an embodiment of an overhead door panel of the door of FIG. 1;

FIG. 3 is a cross-sectional view of the door panel of FIG. 2 and an overlay element coupled thereto;

FIG. 4 is an enlarged view of the encircled portion 4 of FIG. 3;

FIG. 5 is a perspective view of a step of a roll-forming process in accordance with one embodiment of the invention;

FIG. 6 is a cross-sectional view of a panel and an overlay element coupled thereto; and

FIG. 7 is a perspective view of another embodiment of an overlay element in accordance with the principles of this invention.

### DETAILED DESCRIPTION OF THE INVENTION

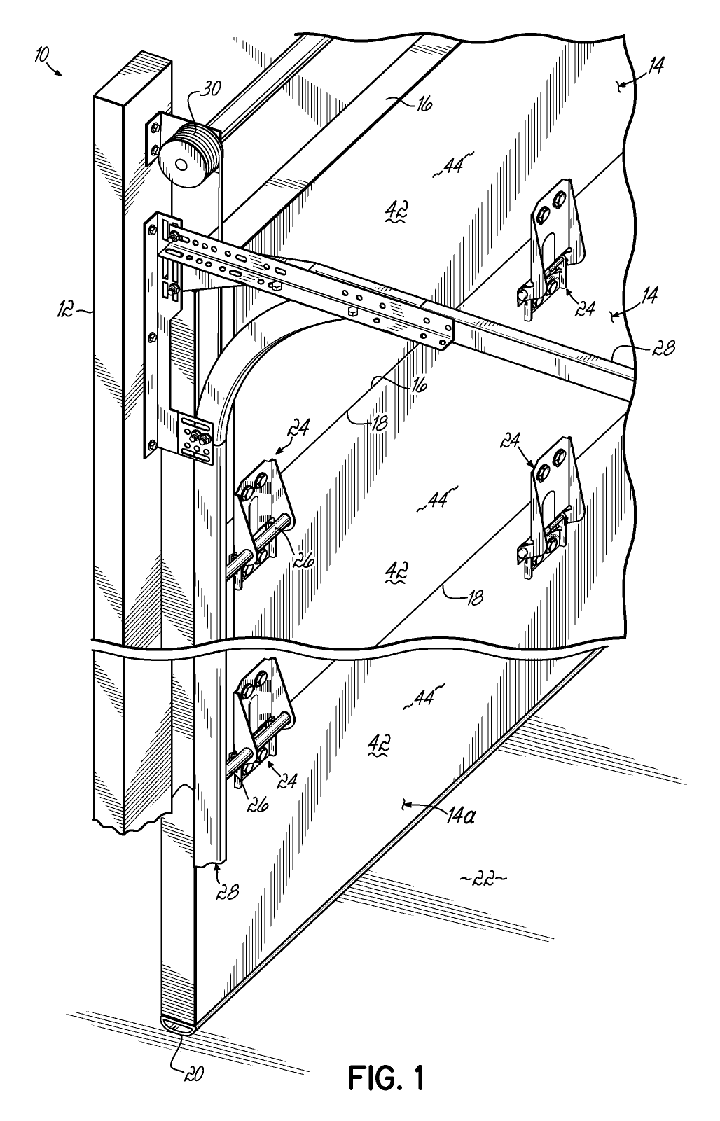

With reference to the drawings and, more particularly, to FIG. 1, a portion of an exemplary embodiment of an overhead door 10 is shown in a closed, generally vertical configuration, covering an opening in a wall 12 of a garage, warehouse or the like. The door lo includes a number of panels 14. Each panel 14 includes upper and lower generally horizontally oriented edges 16, 18 that are configured to mate with corresponding lower and upper edges 18, 16, respectively, of an adjacent panel 14 when the door 10 is in the closed configuration shown in FIG. 1. In one aspect, the lowermost panel 14a of the door 10 may further include an astragal 20 for sealing the door 10 against a floor 22.

The adjacent panels 14 are pivotally connected together by a number of hinge assemblies 24. The hinges 24 positioned proximate the lateral side ends of each panel 14 include a roller assembly 26 for coupling the door 10 to a track assembly 28. Opening and closing of the door 10 may further be facilitated by a counterbalance system 30 coupled to the door 10 as is well known in the art.

With continued reference to FIG. 1, and as noted above, the lower edge 18 of each panel 14 mates with the upper edge 16 of an adjacent panel 14. A more detailed non-limiting disclosure of an exemplary embodiment of a convex/concave joint edge configuration is found in U.S. Pat. No. 6,006,817, assigned to the assignee of this invention and hereby incorporated by reference in its entirety. Nevertheless, the principles described herein are applicable to and readily employable on a door panel design of any configuration of joints, panels or any other configuration.

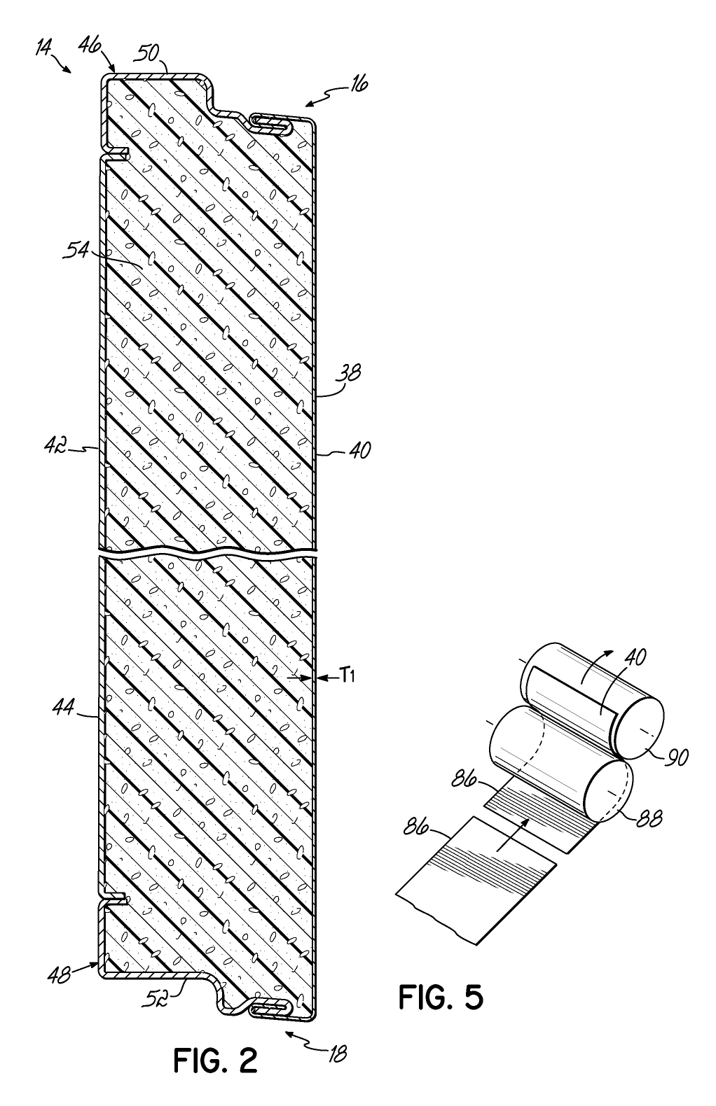

With reference to FIGS. 1-2, an exemplary embodiment of a door panel 14 includes an outer skin 38 having an outer surface 40 and defining a front face of the door panel 14. The door panel 14 may further include a back or inner skin 42 having an inner surface 44 defining, at least in part, a back face of the panel 14. The door panel 14 also includes an upper top rail 46 and a lower bottom rail 48 adapted to mate with corresponding bottom and top rails 48, 46, respectively, of adjacent panels 14. In one aspect of this embodiment, the top and bottom rails 46, 48 are respectively formed from top and bottom rail skins 50, 52, although this aspect is only illustrative and thus not intended to be limiting. Each of the skins 38, 42, 50, 52 may be formed of sheet metal and may further be embossed with a suitably chosen pattern or not embossed at all. In the exemplary embodiment shown in FIG. 2, an insulation member 54 fills an internal volume defined by the inner and outer skins 38, 42 as is well known in the art.

The physical attributes of the door panel 14 may be controlled by one or more variables. For example, the materials defining each of the skins 38, 42, 50, 52, may be suitably chosen. For example, the skins 38, 42, 50, 52 may include a metal such as steel and further include one of many colors, finishes, textures and/or treatments. These exemplary choices for the skins 38, 42, 50, 52 may, for example, affect one or more characteristics thereof such as, and without limitation, their compressive strength, tensile strength, yield strength, thermal expansion or contraction when exposed to specific weather conditions, and corrosion resistance.

In certain embodiments, for example, the outer skin 38 is of metal and has a thickness T₁ of between about 0.010 or less and about 0.04 gage or higher. In certain embodiments, also, the skins 38, 42, 50, 52 may be smooth or embossed with a wood grain or other texture. Similarly, the outer skin 38 may be made of a metal having a specific coefficient of thermal expansion generally referred to herein as coefficient of thermal expansion “a.”

While a lock seam joint configuration is shown in FIG. 2 joining the rail skins 50, 52 and the outer skin 38 together, it should be readily appreciated by those of ordinary skill in the art that other joint configurations and techniques are readily available. Moreover, while distinct skin members 38, 42, 50, 52 are shown joined together to form the door panel 14, a single ply skin material having a portion for the outer skin 38 and corresponding portions for the top and bottom rail skins 50, 52 with equal or variable respective thicknesses are similarly contemplated. Furthermore, another embodiment of this invention may include top and/or bottom rails or outer or inner skins 38, 44 having more than one ply of material.

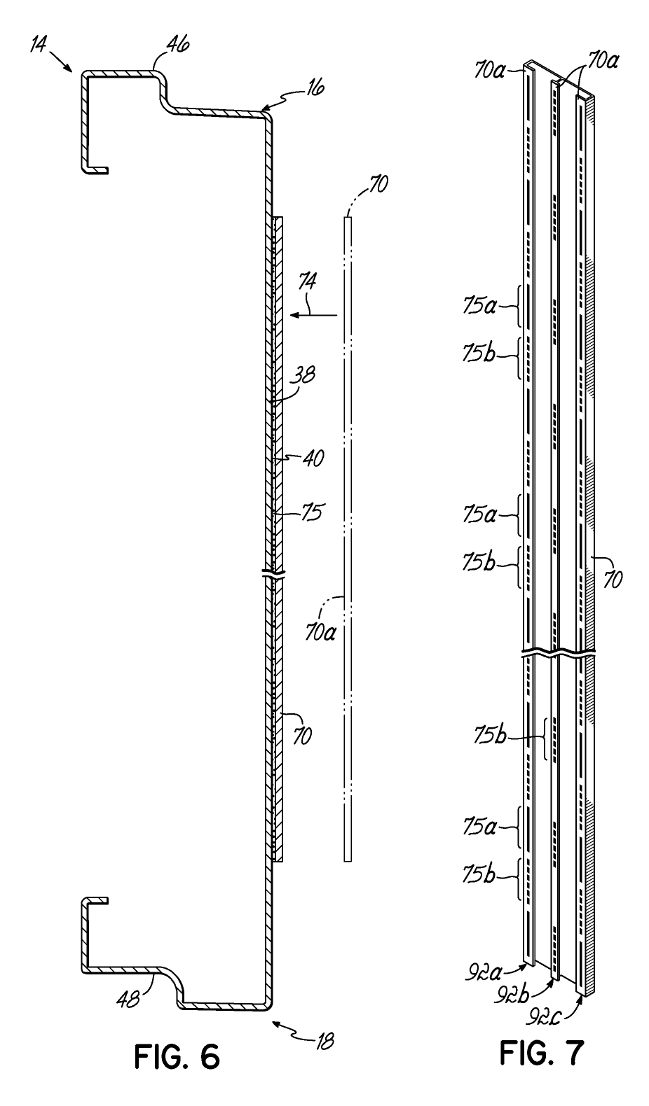

Another exemplary embodiment of a door panel 14 according to this invention is shown in FIG. 6 as a so-called pan door configuration without embedded insulation or a complete back skin. It should be appreciated that many other panel configurations are encompassed within this invention.

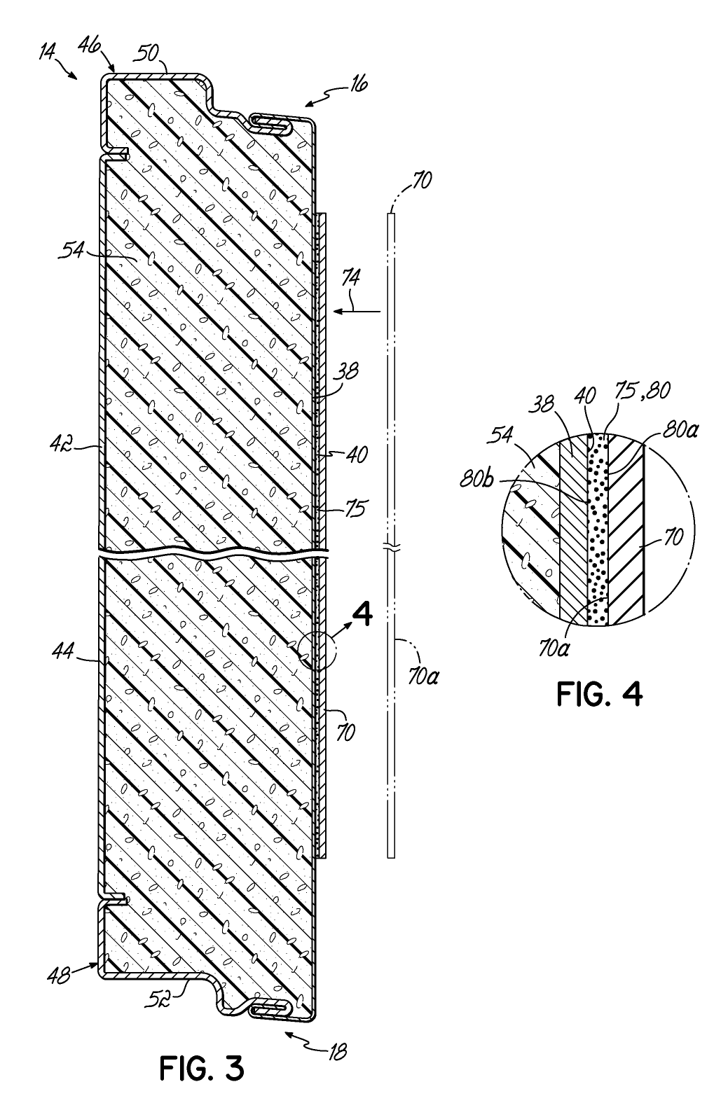

With reference to FIG. 3, a step in coupling of an overlay element 70 and the outer skin 38 is shown. The overlay element 70 could be a structural member providing strength and rigidity to the door panel 14 or alternatively be a decorative member enhancing the appearance of the overhead door 10. The exemplary overlay element 70 is depicted as generally rectangular in cross-section but it may take on any other shape including flat/planar and/or arcuate portions. Similarly, the overlay element 70 may have any size such that it lies within the outer edges of one panel 14 or alternatively extend across more than one panel 14. In another aspect of this embodiment, the overlay element 70 may be of unitary construction or alternatively be made-up of individual components joined together in ways in accordance with the specific materials and shapes of the components. An additional embodiment of an overlay member 70 is shown in FIG. 7.

The overlay element 70 in one embodiment is made of a suitably chosen thermoset material. For example, and without limitation, the thermoset material may be of a type reinforced by fibers. Moreover, the thermoset material may be of a pultruded type. The specific type of thermoset material chosen determines, among other things, the coefficient of thermal expansion thereof, generally referred to herein as coefficient of thermal expansion “b.”

In certain embodiments, the thermoset material may be chosen to have a coefficient of thermal expansion “b” that matches i.e., is substantially equal to the coefficient of thermal expansion “a” of the outer skin 38 and, more particularly, at the outer surface 40 of the outer skin 38. In these embodiments, the proximity of coefficients “a” and “b” of thermal expansion may, for example, be such that there is no visible (i.e., to the human eye) expansion of the outer skin 38 relative to a confronting surface 70a of the overlay element 70.

With reference to FIGS. 3-4, the overlay element 70 is moved generally in a direction indicated by arrows 74, for coupling with the outer skin 38. To this end, in this specific embodiment, an adhesive element 75 may be applied between the confronting surface 70a of the overlay element 70 and the outer surface 40 of the outer skin 38. Those of ordinary skill in the art will appreciate that, alternatively, other non-adhesive methods and/or components may be used to couple the overlay element 70 to the outer skin 38. These may, for example, and without limitation, include mechanical fasteners or the like.

In cases where adhesive is used, an adhesive element such as one in the form of a single layer of adhesive may be applied to the confronting surface 70a prior to coupling with the outer surface 40. Alternatively, the adhesive element may be applied to the outer surface 40 of the outer skin 38 prior to coupling of the overlay element 70 thereto. Alternatively also, the adhesive element may be applied to both surfaces 44, 70a.

With continued reference to FIGS. 3-4, three exemplary (and not limiting) different types of adhesive elements may permit coupling of the overlay element 70 and the outer skin 38. The adhesive element may, for example, take the form of a hot-melt adhesive, of a type well known in the art, thereby taking on the appearance of the general embodiment of adhesive element 75. Similarly, the adhesive element may take the form of a two-part adhesive having respective components to yield an appropriate bond between the surfaces 70a and 40. One example is a quick setting adhesive such as a hot melt glue used in combination with a longer setting adhesive such as methylmethacylate (MMA) glue providing a more secure bond. Likewise, the adhesive element may alternatively take the form of a double sided tape, which includes a main membrane 80 and opposed adhesive layers 80a, 80b respectively configured to adhere to the surfaces 70a and 40 (FIG. 4). Those of ordinary skill in the art will readily appreciate that other types of adhesive elements can be substituted for the exemplary adhesive elements described above.

Referring to FIG. 7, one pattern for application of the two-part adhesive is shown. The overlay member 70 of FIG. 7 has multiple discrete surfaces 92a, 92b and 92c confronting the panel surface 40. Outboard surfaces 92a and 92c include an alternating pattern of approximately two inch long beads of the quick set adhesive 75b and structural adhesive 75a as shown. The center surface 92b includes a series of spaced quick set adhesive beads 75b. Naturally, other adhesive patterns are available within this invention.

With reference to FIG. 5, a diagrammatically represented portion of an exemplary process for forming the door panel 14 is shown. In the step shown, a metal sheet 86 is roll-formed by a pair of rollers 88, 90, which at least partially shape the metal sheet 86 into what will eventually be the outer skin 38, which will in turn become part of the door panel 14. Another step (not shown) in the exemplary process includes molding the overlay element 70 into any desired shape, in ways well known to those in the art for forming structures from a thermoset material. Moreover, a subsequent step includes coupling the overlay element 70 onto the outer surface 40 of the outer skin 38, as explained above in regard to FIGS. 3-4.

It should be readily appreciated that although certain embodiments and configurations of the invention are shown and described herein, the invention is not so limited. From the above disclosure of the general principles of the present invention and the preceding detailed description of exemplary embodiments, those skilled in the art will readily comprehend the various modifications to which this invention is susceptible. For example, while a specific type of overhead garage door is depicted herein, other types of overhead garage doors are contemplated. Therefore, this invention is intended to be limited only by the scope of the following claims and equivalents thereof.

What is claimed is:

1. A garage door comprising:
a plurality of pivotally connected door panels, each of said door panels including an outer skin having an outer surface, said outer skin comprising a metal having a first coefficient of thermal expansion; and
an overlay element coupled to said outer surface of at least one of said skins, said overlay element comprising a fiber-reinforced thermoset material having a second coefficient of thermal expansion.

2. The garage door of claim 1 wherein said first and second coefficients of thermal expansion are substantially equal.

3. The garage door of claim 1 wherein said overlay element further comprises a pultruded fiber-reinforced thermoset material.

4. The garage door of claim 1 further comprising:
an adhesive coupling said overlay element to said outer surface.

5. The garage door of claim 4 wherein said adhesive further comprises a quick-setting adhesive.

6. The garage door of claim 5 wherein said adhesive further comprises a structural adhesive in combination with the quick-setting adhesive glue.

7. The garage door of claim 4 wherein said adhesive further comprises double-sided adhesive tape.

8. The garage door of claim 1 wherein said metal further comprises steel.

9. The garage door of claim 1 wherein said overlay element is a decorative element.

10. A door panel for use as a component of an overhead garage door comprising:
an outer skin having a metallic outer surface with a first coefficient of thermal expansion; and
an overlay element coupled to said outer surface, said overlay element comprising a fiber-reinforced thermoset material having a second coefficient of thermal expansion.

11. The door panel of claim 10 wherein said first and second coefficients of thermal expansion are substantially equal.

12. The door panel of claim 10 wherein said overlay element further comprises a pultruded fiber-reinforced thermoset material.

13. The door panel of claim 10 further comprising:
an adhesive coupling said overlay element to said outer surface.

14. The door panel of claim 13 wherein said adhesive further comprises a quick-setting adhesive.

15. The door panel of claim 13 wherein said adhesive further comprises one of a single-part or a multi-part adhesive.

16. The door panel of claim 13 wherein said adhesive further comprises double-sided adhesive tape.

17. The door panel of claim 10 wherein said outer surface further comprises steel.

18. The door panel of claim 10 wherein said overlay element is a decorative element.

19. A method of making a panel for an overhead door, the door having a plurality of panels pivotally coupled together for movement to and between a generally vertical orientation and a generally horizontal, overhead orientation, the method comprising:
roll-forming a metal sheet into an outer skin of a door panel, the outer skin having an outer surface;
forming an overlay element from a fiber-reinforced thermoset material;
substantially matching a first coefficient of thermal expansion of the metal sheet with a second coefficient of thermal expansion of the fiber-reinforced thermoset material; and
mounting the overlay element onto the outer surface of the outer skin.

20. The method of claim 19 wherein the step of forming the overlay element further comprises:
pultruding the fiber-reinforced thermoset material.

21. The method of claim 19 wherein the mounting step comprises:
applying an adhesive between the overlay element and the outer surface of the outer skin.
